(19) United States
(12) Patent Application Publication
(10) Pub. No.: US 2018/0096437 A1
(43) Pub. Date: Apr. 5, 2018

(54) Facilitating Like-Minded User Pooling

(71) Applicant: Aiooki Limited, Grand Cayman (KY)

(72) Inventors: Lam Sun, Foster City, CA (US); Boxiong Ding, San Jose, CA (US); Kuan-Cheng Lai, Santa Clara, CA (US)

(21) Appl. No.: 15/472,228

(22) Filed: Mar. 28, 2017

Related U.S. Application Data
(60) Provisional application No. 62/404,714, filed on Oct. 5, 2016.

(51) Int. Cl. G06Q 50/00; G06N 99/00; G06Q 40/06

(52) U.S. Cl. CPC G06Q 50/01; G06Q 40/06; G06N 99/005

(57) ABSTRACT

Some embodiments can provide a user matching system configured to match a list of one or more users to a given user. The user matching system can be configured to employ a stage learning process including a user compatibility learning stage, an affinity learning stage, and a match optimization stage. In various exemplary implementations, various user data regarding user preferences, user traits, user behaviors, and/or any other user aspects can be collected. In those implementations, the user matching system is configured to divide the users into different user groups based on the learned user attributes, and determine similarities among users within a given group based on the user attributes. In this way, one or more users can be identified and can be suggested to the given user based on their similarities to the given user.

### CROSS-REFERENCE TO RELATED APPLICATIONS

The present application claims priority to U.S. Provisional Patent Application No. 62/404,714, filed on Oct. 5, 2016 and entitled “ENHANCED USER MATCHING, RECOMMENDATION AND PREDICATION SYSTEMS”, the disclosures of which is hereby incorporated by reference in their entireties for all purposes.

### BACKGROUND OF THE INVENTION

The disclosure relates to user matching and generating recommendation for users using a computer system.

User matching is generally known in the art. Existing user matching technologies typically match users based on their preferences or certain user characteristics. For example, two users may be matched simply based on their geographical locations. Under the existing user matching technologies, the user matching may be refined until an acceptable result is obtained. For example, the conventional matching technologies may first start with a big group of users that can be matched based on their generally geographical regions (e.g., their current countries), and fine-tuned to match their finer locations as desired (e.g., their current cities).

Recommendation systems are generally known in the art. Existing recommendation systems typically recommend an entity (e.g., a website) to a user based on a relationship between the recommended entity and the user's interest. For example, some of the existing recommendation systems are configured to collect data regarding user browsing activities and analyze such data to learn the user's interest. These systems are also configured to determine a likelihood the user will visit the website based on the learned user interest and select a website for recommendation to the user based on the determined likelihood the user will visit the website.

Bidding systems are generally in the art. Existing bidding systems are typically configured to receive user bids for a certain item. A given user bid that is received by the existing bidding systems typically a user determined price and an identification of the given item. The existing bidding systems are typically configured to compare all received user bids to determine a winning bid.

### BRIEF SUMMARY OF THE INVENTION

Some embodiments can provide a user matching system configured to match a list of one or more users to a given user. In various exemplary implementations of the user matching system in accordance with the disclosure, various user data regarding user preferences, user traits, user behaviors, and/or any other user aspects can be collected. Certain user attributes can then be learned by the user matching system based on the collected user data. In those implementations, the user matching system is configured to divide the users into different user groups based on the learned user attributes, and determine similarities among users within a given group based on the user attributes. In this way, one or more users can be identified and can be suggested to the given user based on their similarities to the given user. Compared with the traditional user matching technologies mentioned above, the user matching technology in accordance with the disclosure employs a divide and conquer approach, where a part of the problem is solved at a single stage. Three stages can be roughly characterized in this approach: compatibility learning (where the users are grouped based on learned user attributes), affinity learning (where similarities between the users within individual groups are determined), and match optimization (where matching suggestions are made).

In one embodiment, the user matching system in accordance with the disclosure is configured to provide a list of users that can be pooled together for a common goal based on their attributes learned by the user matching system. In one embodiment, the user matching system in accordance with the disclosure is used to suggest one or more like-minded investors to a given investor to enable the given investor to determine whether to invite the suggested investors for a joint investment.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

FIG. 1 conceptually illustrates one example of a three stage user similarity learning process in accordance with the disclosure.

FIG. 2 illustrates some examples of user attributes that can be used to divide the users into different user groups during the user compatibility stage in accordance with the disclosure.

FIG. 3A illustrates one example of a questionnaire that can be used to collect ordinal data from the user regarding investment factors about the users.

FIG. 3B illustrates one example of investment factors regarding the individual users that can be obtained

FIG. 4 illustrates conceptually dividing users into different groups based on one or more user attributes during a user compatibility stage.

FIG. 5 illustrates an example result of K-means clustering on investment factors regarding individual users.

FIG. 6 shows one example of a user to user matrix with respect to investment factors.

FIG. 7A shows one example matrix of user activity data for property viewing behavior.

FIG. 7B conceptually illustrate user preferences can be built on property's latent features.

FIG. 7C illustrates how each property can be related to the same set of latent features.

FIG. 8 illustrates an example of a user matching system in accordance with the disclosure.

FIG. 9 illustrates an exemplary method for matching users and making a recommendation to a given user based on the user matching.

FIG. 10 illustrates an exemplary method for matching users and recommending similar users to a given user for co-investing.

FIG. 11 is a block diagram of computer system that can be used to implement various embodiments described and illustrated herein.

### DETAILED DESCRIPTION OF THE INVENTION

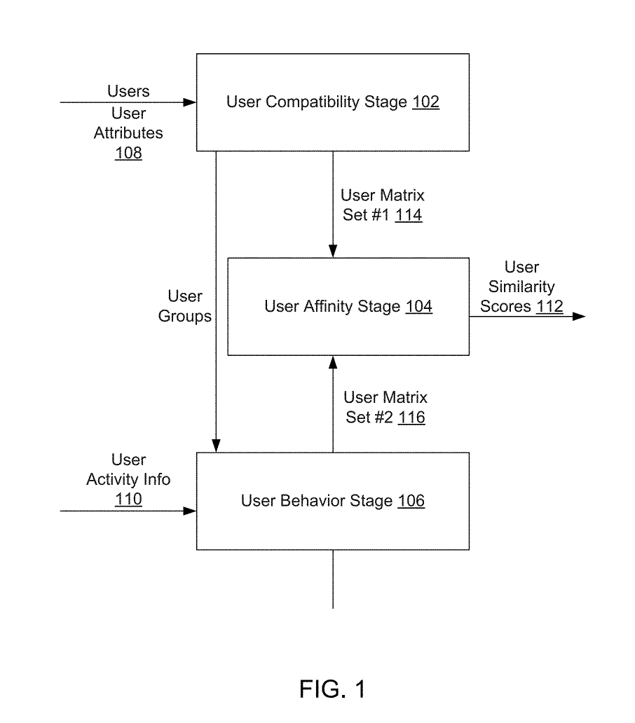

In some embodiments, a user matching system is provided. The user matching system can be configured with various machine learning techniques to perform a three stage process to calculate a matching score (i.e., similarity score) that measures the similarity between users. FIG. 1 conceptually illustrates one example of a three stage user similarity learning process in accordance with the disclosure. As shown, the three-stage user similarity learning process can include: a user compatibility learning stage 102, an user affinity learning stage 104, and a user behavior learning stage 106. In the user compatibility learning stage 102, one or more sets of user attributes 108 can be obtained for individual users. The set(s) of user attributes can be used to divide the users into different user groups. In some embodiments, during the user compatibility stage 102, an unsupervised machine learning technique can be employed by the user matching system to divide the users into different groups based on the set(s) of user attributes. One exemplary technique that can be used for such grouping can include k-means clustering. Other similar techniques can be used by the user matching system in accordance with the disclosure to serve that purpose.

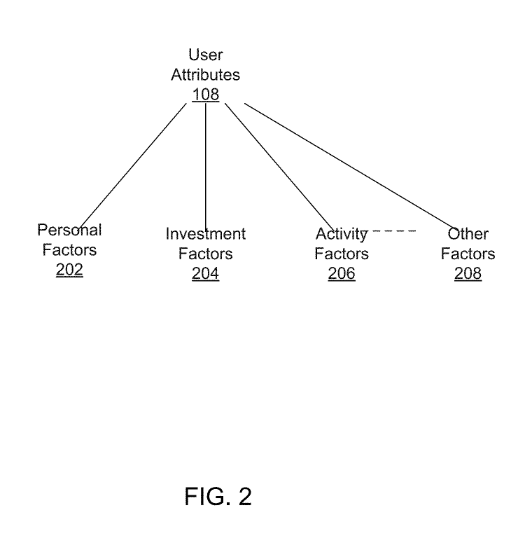

The set(s) of user attributes that can be used to divide the users into different groups during user compatibility stage 102 may include various attributes as however desired depending on an application of the user matching system. FIG. 2 illustrates some examples of user attributes that can be used to divide the users into different user groups during the user compatibility stage 102 in accordance with the disclosure. As shown, the sets of user attributes can include personal factors 202 regarding the users, which can include information indicating personal backgrounds for the users. Examples of the personal factors 202 can include information about occupation, education, age, gender, ethnicity, income level, current residence, marital status, and/or any other personal factors regarding the individual users. In some embodiments, the set(s) of attributes 108 may include investment factors 204 regarding the individual users, which can include information indicating investment preferences and goals of the users. Examples of the investment factors 204 regarding the users can include information regarding whether the user is a hands-on investor, an active or passive investor, has a tendency to share on social media, travel experiences, level of investment experiences, cash flow or appreciation; short term or long term; invest locally or remotely; willing to deal with HOA or not; type of property: SFH/condo/townhouse; location preference: suburb, downtown, college campus, etc; risk tolerance; invest for retirement, college fund, or building wealth and/or any other investment factors.

In some embodiments, the set(s) of attributes 108 may include user activity factors 206 regarding the individual users, which can include information indicating certain web viewing behavior about the individual users. Examples of the user activity factors 206 can include information regarding which web items the users have viewed, duration of viewing the web items by the individual users, number of times the users have viewed the web items, a context in which the users viewed the web items. In one embodiment, the user matching system is used for recommending and group investors for investment, which can include real-estate, stock, commodity, and/or any other type of investments. In that embodiment, the user activity factors 206 can include information indicating which markets that have been viewed by the users, which investment properties (e.g., real-estate, stock, commodity or any other types of investment) that have been viewed by the users, a number of times the users have viewed those investment properties through respective web outlets (e.g., websites or apps), which sections of the investment information are viewed by the users (e.g., which floor plans, which stock disclosures, which investment prospectuses), which documents regarding the investment are viewed by the users, a number of times the investment is shared by the users (e.g., the users shared the investment with other users via email or social media), which filters were used by the users to view the investment (e.g., price, number of beds, year built, lot size, etc.), whether the users have invited other users to view the investment, and/or any other user activity data regarding the user viewing of the investment.

It should be understood during the user compatibility stage 102, one or more sets of the user attributes 108 can be used to divide the users into different groups. In one embodiment, the investment factors 204 regarding the individual users are used to divide the users into different groups such that users with similar investment goals and preferences are assigned to the same user group. However, this is not intended to be limiting. In another example, the personal factors 202 regarding the individual users are used to divide the users into different groups such that users with similar personal backgrounds are assigned to the same user group. In still another example, the personals factors 202 and the investment factors 204 regarding the individual users can both be used during the user compatibility stage 102 to divide users into different groups such that users with similar investment goals and preferences as well as similar personal backgrounds are assigned to the same group.

The source(s) for obtaining the set(s) of user attribute 108 may vary depending the application of the user matching system in accordance with the disclosure. For example, the user attributes may be obtained from user manifested data (e.g., online questionnaires, or user provided user profiles), user activity data within a browser, a website or an app, information regarding the users provided by a third party entity affiliated with the provider(s) of user matching system (e.g., a user data vendor), and/or any other data sources. Obtaining the user attributes 108 from the data source(s) may involve processing the data from the data source(s) and extract information matching pre-defined tokens representing the user attributes 108.

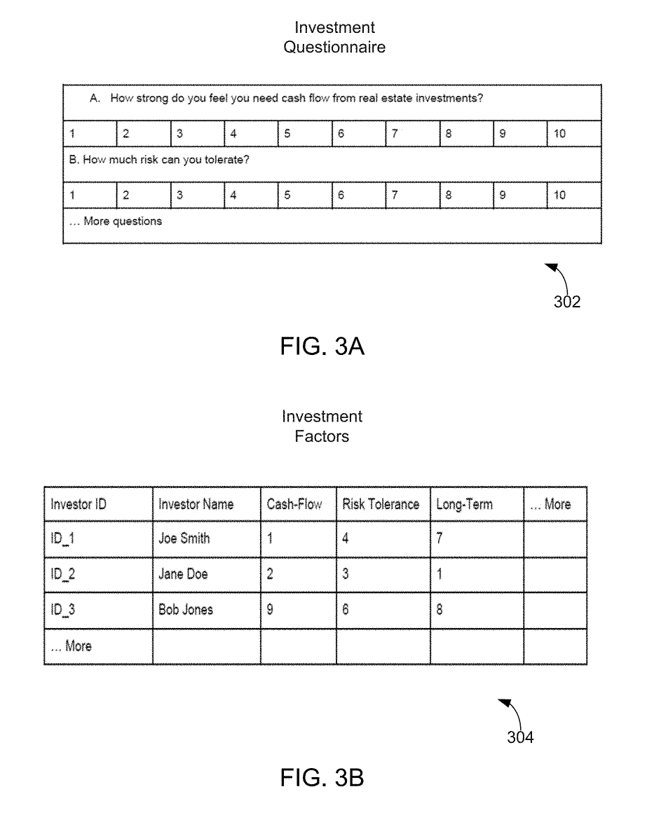

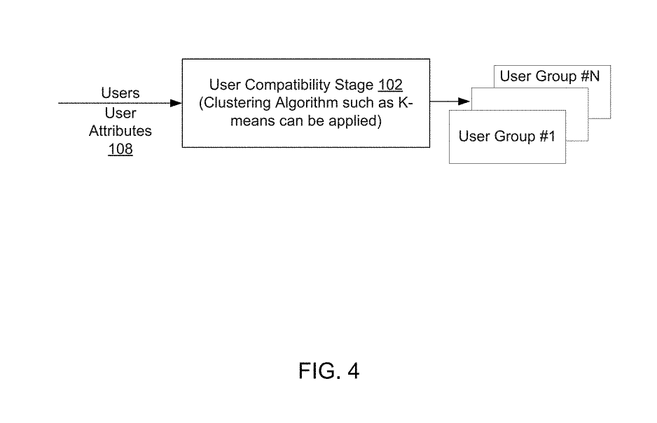

Referring to FIG. 4, as mentioned above, various machine learning techniques can be employed in the user compatibility stage 102 to divide the users based on the set(s) of user attributes 108. One exemplary technique that can be used to divide the users into different groups is K-means clustering. In some exemplary implementations where K-means clustering is used, ordinal data and categorical data representing the set(s) of user attributes 108 can be used. For ordinal data, values for a particular user attribute 108 are scaled into 1 to 10. For instance, when the investment factors 204 are used, a value from 1-10 can be used to indicate how much the investor prefer cash flow. For categorical data, values of the user attributes 108 can be scaled into dummy's form. For instance, category value such as: single family house (SFH), condo, townhouse and duplex can be used to indicate what type of real-estate property the investor prefers: for example SFH, condo, townhouse, or duplex. FIG. 3A illustrates one example of a questionnaire 302 that can be used to collect ordinal data from the user regarding investment factors about the users. FIG. 3B illustrates one example of investment factors 204 regarding the individual users that can be obtained.

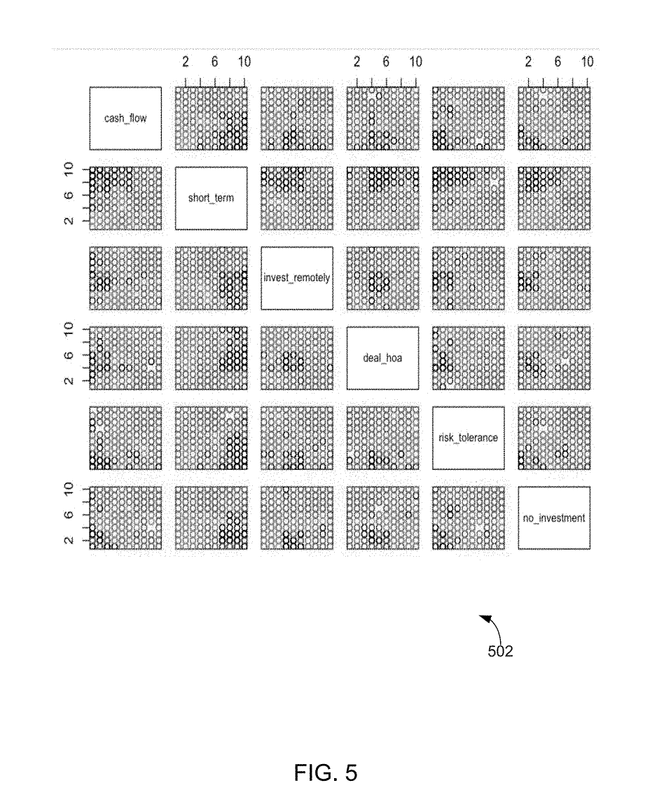

In some exemplary implementations, K-means clustering can be applied to the user attributes 108 such as the investment factors 204 shown in FIG. 3B to divide the users into different groups. In those implementations, this process works as a filter to make the subsequent learning (e.g., user affinity and behavior) more targeted. K-means clustering is well understood by one skilled in the art and thus will not be described in detail for clarity. An example result of the K-means clustering on investment factors regarding the individual users is shown in FIG. 5, where users are divided into three groups. As shown, the FIG. 502 in this example projects the multi-dimensional result into 2 dimensional chart with each square represents a feature space. In 502, the users are segregated into 3 groups (each color represents a group) based on their investment factors. Each group represents users with similar investment goal under different features space.

Referring back to FIG. 1, during the user affinity stage 104, affinity or similarity between the users in a given user group can be learned. In some exemplary implementations, the affinity learning between the users in the given group can involve calculating distances between any two users with respect to a first set of attributes and a second set of attributes. For example, when the user matching system is applied to matching users for investment, the first set of attributes can include investment factors 204 described and illustrated herein, and the second set of attributes can include personal factors 202 described and illustrated herein. In that example, those users who have both similar investment goals (in the same cluster in user compatibility stage 102) and similar personal backgrounds are assigned to higher similarity score. In implementations, Euclidean distance can be calculated between users in the feature space of investment factors 204 and personal factors 202. For those users who have shorter distance in both feature spaces, they may end up with a higher similarity score with respect to each other which means they are supposed to be grouped in the same team.

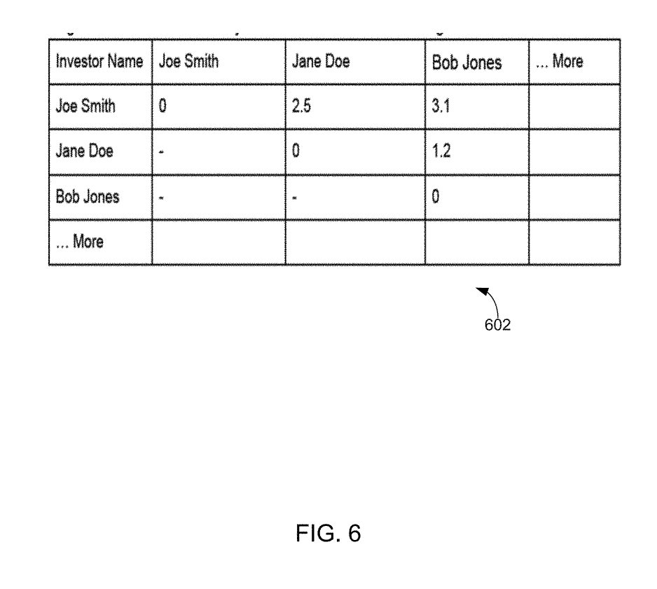

In one implementation, the Euclidean distance between any two users with respect to a given set of attributes (e.g., investment factors) can be calculated as follows: First, the square of difference between any two users for each factor in the set can be calculated. For example, referring to FIG. 3B, the differences between any two users with respect to cash flow, risk tolerance, long-term plan, and other investment factors can be calculated. Second, the square of all factor differences between any two users can be added to obtain the Euclidean distance with respect to the investment factors. Other distance calculation such as one norm distance can also be used in some other embodiments. The resulting difference can be stored in a user-to-user matrix where each value in the matrix can represent the similarity distance between two users from the row and column of the matrix. FIG. 6 shows one example of a user to user matrix 602 with respect to investment factors. The user matrix 602 can be calculated from the investment factor values for the users shown in FIG. 3B. As shown, the distance between the same user is zero and is represented in the diagonal cells. The distance between user A and B is the same as the distance between user B and A so only half of the matrix 602 is used. There is no unit for the distances and the values depend on the scales used in the measurement in FIG. 3B. The same method described above can be applied using users' personality factors to generate a second matrix similar to matrix 602 shown in FIG. 6.

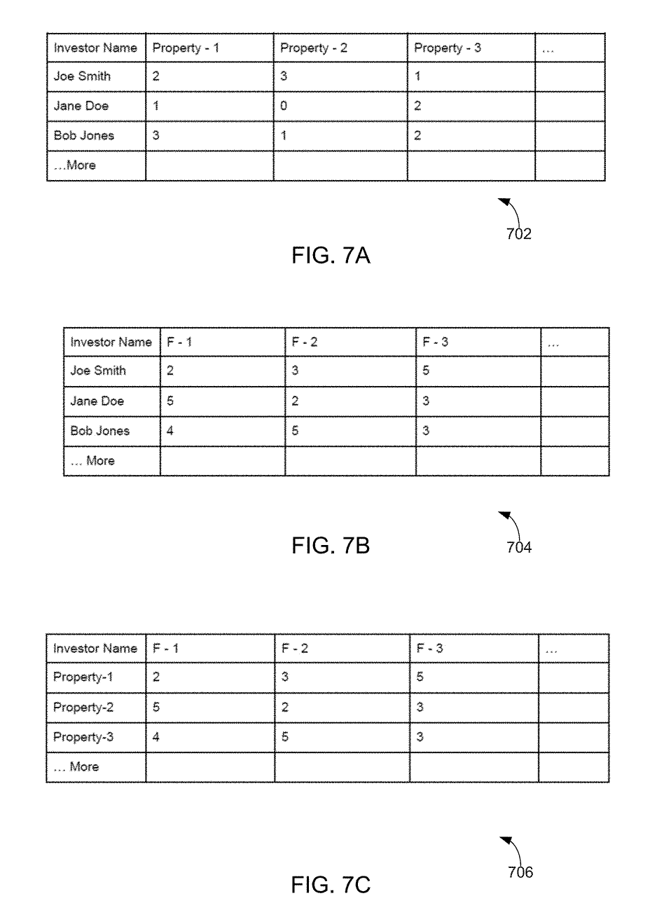

Referring back to FIG. 1, during the user behavior stage 106, the users that have been assigned to different groups during user compatibility stage 102 can be further learned with respect to their online viewing activities. As mentioned above, user activity data 110 can be obtained to analyze user viewing activities in this stage. The user activity data can include information indicating various aspects regarding user viewing of a webpage or a web item. When the user matching system is applied to investment, the user activity data can include one or more properties and investments a given user has viewed, how many times the user has viewed each, and any other user activity data with respect investment viewing as described and illustrated herein. FIG. 7A shows one example matrix 702 of user activity data for property viewing behavior. The number in each cell in matrix 702 show the number of time the used viewed a specific property. In some exemplary implementations, during user behavior stage 106, a collaborative filtering algorithm can be applied to the user activity data to learn how similar two users' online viewing behavior is. For example, when the user matching system is applied to investment, two user-to-user matrixes can be built. One can be built to the users' preferences on property's latent feature as shown in FIG. 7B. Another is to show how each property is related to the same set of latent feature as in FIG. 7C.

In some exemplary implementations, the matrix 704 and matrix 706 shown in FIGS. 7B-C can be built as follows: first, matrixes 704 and 706 can be populated with random numbers. Then, matrix 704 can be multiplied by the transpose of matrix 706 to obtain a product. A gradient decent algorithm can be applied to the matrix 702 in FIG. 7A and the product until the predefined threshold of lowest cost is reached. At this point the matrix 704 represents the learned user's preference in each latent feature from the property viewing behavior. A distance between any two users can be calculated using Euclidean distance, which will result in a third investor-to-investor matrix. The same or similar method can be applied to investor's investment viewing behavior to obtain a fourth matrix that represents the user distance in terms of investment viewing preference.

As should be clear, after the three stage 102, 104, and 106 shown FIG. 1, multiple user-to-user matrixes can be constructed. For example, using the examples described above, four user-to-user matrixes can be constructed: from investment factor, from personality factor, from property viewing behavior, and from investment viewing behavior. A similarity score can then be calculated by taking a reciprocal of each distance and applying a weight. The weight denotes the importance of each distance. The formula is:

SC=W1/M−i+W2/M−p+W3/M−bp+W4/M−bi.

Where SC is the finals similarity score. W1 through W4 are weights given to each factor. M−i is the matrix for investment factor, M−p is the matrix for personality factor, M−bp is the matrix for property viewing behavior and M−bi is the matrix for investment view behavior.

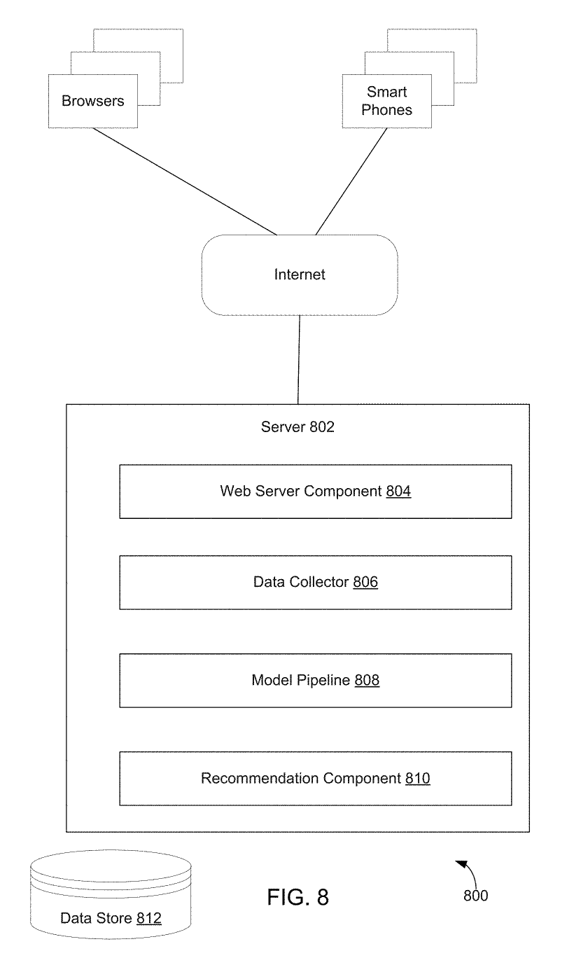

With various working principles of a user matching system having been generally described above, attention is now directed to FIG. 8 where an example of user matching system 800 in accordance with the disclosure is illustrated. As shown, the user matching system 800 can include a server 802. The server 802 can include one or more computer components including a web server component 804, a data collector 806, a model pipe line 808, a recommendation component 810, and/or any other components.

The web server component 804 can be configured to receive, via an internet, data requests from user applications such as browsers and apps as shown. The web server component 804 can be configured serve web pages to the user applications. In some embodiments, the web server component 804 can be configured to receive user data, such as user answers to questionnaire posted on one or more pages served by the web server component 804.

The data collector 806 can be configured to collect various user data as described and illustrated herein. The user data can be categorized for different purposes, and can be used in different models. In one embodiment, three categories are used: investment factors, personality factors and behavior factors as described and illustrated herein. In some exemplary implementations, the data collector 806 can be configured to obtain user data by presenting online questionnaires for user to provide answers. For example, the web server component 804 can be configured to present such questionnaires to the users via their browsers or apps. Once the users provide answers to the questionnaires and the web server component 804, the web server component 804 can be configured to forward the answer data to the data collector 806. The data collector 806 can be configured to extract relevant values from the user provided answers. However, this is not intended to be limiting. In some examples, the web server component 804 can be configured to receive browser cookies or app logs from the user applications and forward to the data collector 806. In those examples, the data collector 806 can be configured to parse the browser cookies or app logs to obtain various user data, for example the user activity data described and illustrated herein.

The model pipeline 808 can be configured to perform the three stage user learning process as described and illustrated in FIGS. 1-7. The model pipeline 808 can be configured to apply data modeling using series of machine learning techniques to quantify how users are similar. Similarity scores can be determined between two users by the model pipeline 808. As described above, multiple matrixes can be built from various user data during the three stage user learning by the model pipeline 808. For example, the four user-to-user matrixes: personality, investment, property viewing and investment viewing described and illustrated herein can be constructed by the model pipeline 808 and stored in data store 812.

The recommendation component 810 can be configured to match a given user with one or more users that have highest similarity scores with respect to the given user. The user matching by the recommendation component 810 can be based on the result from the modeling pipeline 808. Various recommendations can be made by the recommendation component 810. For example, a recommendation can be made by the recommendation component 810 when a given user is looking for more users to co-invest an investment. In that example, the recommendation component 810 can be configured to provide a list of investors that has the highest similarity scores. In this way, similar users can be recommended to the given user enable the given user to invite those users to co-invest, for example a real-estate property. As another example, the recommendation component 810 can be configured to provide the given user a list of web items that have been viewed or purchased by users that have high similarity scores to the given user. For instance, the recommendation component 810 can be configured provide the given user a list of real-estate properties that have been purchased by the users that are similar to the given user as determined by the model pipeline 808. Still as another example, the recommendation component 810 can be configured to pool similar users based on the similarity scores determined by the model pipeline 808 and provide a recommendation to the user pool. For instance, the recommendation component 810 can be configured to recommend a real-estate property for investment to the user pool.

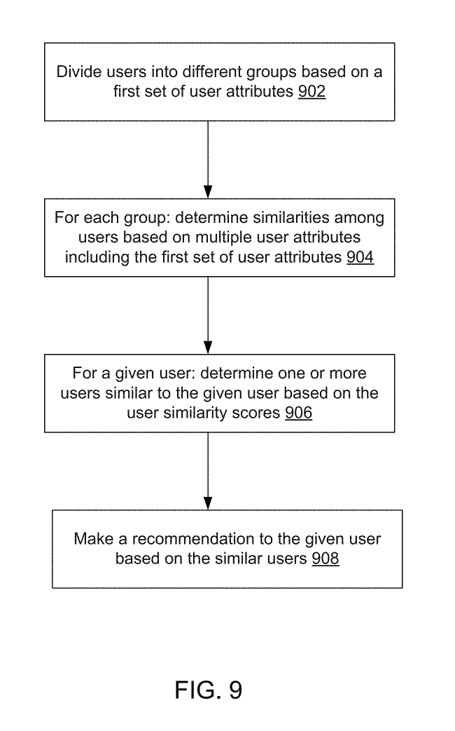

FIG. 9 illustrates an exemplary method 900 for matching users and making a recommendation to a given user based on the user matching. The method presented in FIG. 9 and described below is intended to be illustrative and non-limiting. The particular series of processing steps depicted in FIG. 9 is not intended to be limiting. It is appreciated that the processing steps may be performed in an order different from that depicted in FIG. 9 and that not all the steps depicted in FIG. 9 need be performed.

In some embodiments, the method depicted in method 900 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900.

At 902, individual users can be divided into different groups based on a first set of user attributes. For examples, as described above, K-means clustering can be employed in 902 to divide the users based on their personal backgrounds. In some exemplary implementations, operations involved in 902 can be implemented by a model pipeline the same as or substantial similar to the model pipeline 808 described and illustrated herein.

At 904, for each group divided at 902, similarities between any two users in the group can be determined based on multiple user attributes including the first set of user attributes. For example, as described above, multiple user-to-user matrixes can be constructed based on the user attributes. Euclidean distances can be determined for any two users for those matrixes and a similarity score can be determined for the two users based on the Euclidean distances. In some exemplary implementations, operations involved in 904 can be implemented by a model pipeline the same as or substantial similar to the model pipeline 808 described and illustrated herein.

At 906, one or more users that are similar to a given user can be determined based on the similarity scores determined at 904. In some exemplary implementations, a predetermined similarity score threshold can be employed at 906. In those implementations, users with similarity scores with respect to the given user above the threshold can be identified at 906. In some exemplary implementations, operations involved in 906 can be implemented by a recommendation component the same as or substantial similar to the recommendation component 810 described and illustrated herein.

At 908, a recommendation can be made to the given user based on the similar users determined at 906. For example, one or more web items that have been viewed by the similar users can be recommended to the given user. The web items may include a particular product, a web page, a news story, a particular content, and/or any other web items. In some exemplary implementations, operations involved in 906 can be implemented by a recommendation component the same as or substantial similar to the recommendation component 810 described and illustrated herein.

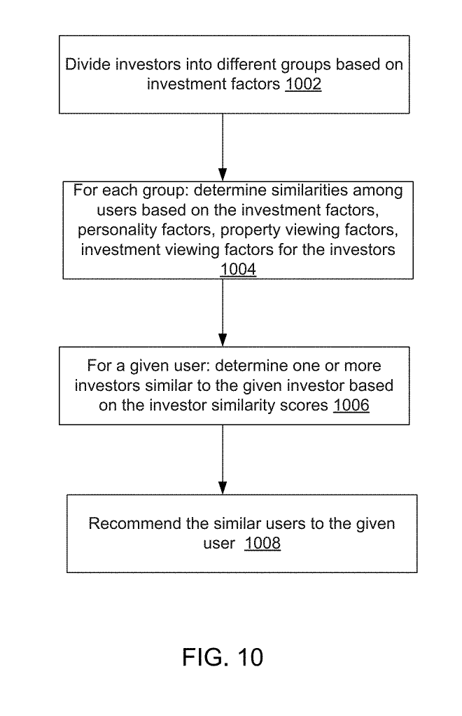

FIG. 10 illustrates an exemplary method 1000 for matching users and recommending similar users to a given user for co-investing. The method presented in FIG. 10 and described below is intended to be illustrative and non-limiting. The particular series of processing steps depicted in FIG. 10 is not intended to be limiting. It is appreciated that the processing steps may be performed in an order different from that depicted in FIG. 10 and that not all the steps depicted in FIG. 10 need be performed.

In some embodiments, the method depicted in method 1000 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1000 in response to instructions stored electronically on an electronic storage medium. The one or more processing devices may include one or more devices configured through hardware, firmware, and/or software to be specifically designed for execution of one or more of the operations of method 1000.

At 1002, investors can be divided into different investor groups based on investment factors regarding the investors. For examples, as described above, K-means clustering can be employed in 1002 to divide the investors based on their investment preferences and goals. In some exemplary implementations, operations involved in 1002 can be implemented by a model pipeline the same as or substantial similar to the model pipeline 808 described and illustrated herein.

At 1004, for each group divided at 1002, similarities between any two investors in the investor group can be determined based on personality factors, investment factors, property viewing factors, and investment viewing factors regarding the individual investors as described and illustrated herein. As described above, four investor-to-investor matrixes can be constructed based on those factors. Euclidean distances can be determined for any two users for those matrixes and a similarity score can be determined for the two investors based on the Euclidean distances. In some exemplary implementations, operations involved in 1004 can be implemented by a model pipeline the same as or substantial similar to the model pipeline 808 described and illustrated herein.

At 1006, one or more investors that are similar to a given investor can be determined based on the similarity scores determined at 1004. In some exemplary implementations, a predetermined similarity score threshold can be employed at 1006. In those implementations, users with similarity scores with respect to the given investor above the threshold can be identified at 1006. In some exemplary implementations, operations involved in 1006 can be implemented by a recommendation component the same as or substantial similar to the recommendation component 810 described and illustrated herein.

At 1008, the similar investors as determined at 1004 can be recommended to the given investor for co-investing. In some exemplary implementations, operations involved in 906 can be implemented by a recommendation component the same as or substantial similar to the recommendation component 810 described and illustrated herein.

Below is a scenario that describes recommending investors to the given investor for co-investing by the user matching system 800. It starts when the given investor browses investment properties. The matching system 800 can provide a list of properties that is already invested by like-minded or the similar investors as determined by the model pipeline 808. The given investor decides to invest in a specific investment property, which could be the one recommended by the user matching system 800, but it does need to be. After the given investor selects the property as investment target, the given investor can be provided an opportunity to invite other people to co-invest. The given investor can invite the people he already know, and at the same time the user matching system 800 can provide a list of investors that has like-mind as the given investor. The list can be ordered by similarity scores from the modeling pipeline 808 with the most similar ones on the top. Only a limited number of similar investors may be provided by the user matching system 800. For each investor in the list, basic information will be provided, such as location, profession, experience level, to help initiating investor make selections. After reviewing each recommended investors, the given investor can send invitation to selected similar investors. The invitation can be an email or in-system message. If the invited investor chooses to accept the invitation, he will need to go through the joining process to become part of the investment. The fact that an investor accepts or declines the invitation will help to refine the recommendation result in the future for the user matching system 800.

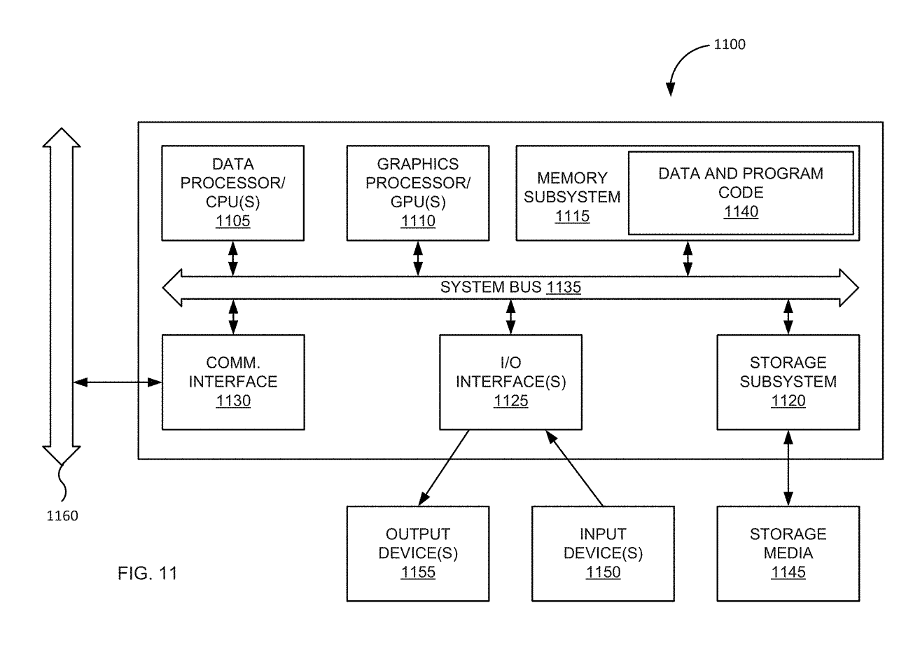

FIG. 11 is a block diagram of computer system 1100 that can be used to implement various embodiments described and illustrated herein. FIG. 11 is merely illustrative. In some embodiments, a computer system includes a single computer apparatus, where the subsystems can be the components of the computer apparatus. In other embodiments, a computer system can include multiple computer apparatuses, each being a subsystem, with internal components. Computer system 1100 and any of its components or subsystems can include hardware and/or software elements configured for performing methods described herein.

Computer system 1100 may include familiar computer components, such as one or more one or more data processors or central processing units (CPUs) 1105, one or more graphics processors or graphical processing units (GPUs) 1110, memory subsystem 1115, storage subsystem 1120, one or more input/output (I/O) interfaces 1125, communications interface 1130, or the like. Computer system 1100 can include system bus 1135 interconnecting the above components and providing functionality, such connectivity and inter-device communication.

The one or more data processors or central processing units (CPUs) 1105 can execute logic or program code or for providing application-specific functionality. Some examples of CPU(s) 1105 can include one or more microprocessors (e.g., single core and multi-core) or micro-controllers, one or more field-gate programmable arrays (FPGAs), and application-specific integrated circuits (ASICs). As used herein, a processor includes a multi-core processor on a same integrated chip, or multiple processing units on a single circuit board or networked.

The one or more graphics processor or graphical processing units (GPUs) 1110 can execute logic or program code associated with graphics or for providing graphics-specific functionality. GPUs 1110 may include any conventional graphics processing unit, such as those provided by conventional video cards. In various embodiments, GPUs 1110 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 1110 may include any number of registers, logic units, arithmetic units, caches, memory interfaces, or the like.

Memory subsystem 1115 can store information, e.g., using machine-readable articles, information storage devices, or computer-readable storage media. Some examples can include random access memories (RAM), read-only-memories (ROMS), volatile memories, non-volatile memories, and other semiconductor memories. Memory subsystem 1115 can include data and program code 1140.

Storage subsystem 1120 can also store information using machine-readable articles, information storage devices, or computer-readable storage media. Storage subsystem 1120 may store information using storage media 1145. Some examples of storage media 1145 used by storage subsystem 1120 can include floppy disks, hard disks, optical storage media such as CD-ROMS, DVDs and bar codes, removable storage devices, networked storage devices, or the like. In some embodiments, all or part of data and program code 1140 may be stored using storage subsystem 1120.

The one or more input/output (I/O) interfaces 1125 can perform I/O operations. One or more input devices 1150 and/or one or more output devices 1155 may be communicatively coupled to the one or more I/O interfaces 1125. The one or more input devices 1150 can receive information from one or more sources for computer system 1100. Some examples of the one or more input devices 1150 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 1150 may allow a user of computer system 1100 to interact with one or more non-graphical or graphical user interfaces to enter a comment, select objects, icons, text, user interface widgets, or other user interface elements that appear on a monitor/display device via a command, a click of a button, or the like.

The one or more output devices 1155 can output information to one or more destinations for computer system 1100. Some examples of the one or more output devices 1155 can include a printer, a fax, a feedback device for a mouse or joystick, external storage systems, a monitor or other display device, a communications interface appropriately configured as a transceiver, or the like. The one or more output devices 1155 may allow a user of computer system 1100 to view objects, icons, text, user interface widgets, or other user interface elements. A display device or monitor may be used with computer system 1100 and can include hardware and/or software elements configured for displaying information.

Communications interface 1130 can perform communications operations, including sending and receiving data. Some examples of communications interface 1130 may include a network communications interface (e.g. Ethernet, Wi-Fi, etc.). For example, communications interface 1130 may be coupled to communications network/external bus 1160, such as a computer network, a USB hub, or the like. A computer system can include a plurality of the same components or subsystems, e.g., connected together by communications interface 1130 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

Computer system 1100 may also include one or more applications (e.g., software components or functions) to be executed by a processor to execute, perform, or otherwise implement techniques disclosed herein. These applications may be embodied as data and program code 1140. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 1115 and/or storage subsystem 1120.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

1. A method for generating a recommendation to a first user, the method being implemented by a processor configured to execute computer program components, the method comprising:
receiving information regarding users from user devices associated with the users;
dividing the users into user groups using the received information based on a first set of one or more user attributes regarding the users, the user groups including a first user group;
for each user group:
determining similarity scores among the users in the group based on the first set of one or more user attributes;
receiving, from a user device associated with a first user, a request for recommending users to the first user, the first user being in the first user group;
in response to the request from the first user:
determining one or more users similar to the first user such that each of the one or more users has a similarity score with respect to the first user that is above a threshold similarity score; and
generating a recommendation for presentation on the user device associated with the first user based on the one or more users similar to the first user.

2. The method of claim 1, wherein the first set of one or more user attributes include one or more personal factors regarding the users, one or more investment factors regarding the users, and/or one or more web viewing factors regarding the users.

3. The method of claim 1, wherein dividing the users into user groups using the received information based on the first set of one or more user attributes comprises:
applying K-means clustering to the users based on the first set of one or more user attributes.

4. The method of claim 1, wherein determining the similarity scores among the users in the group based on multiple user attributes including the first set of one or more user attributes comprises:
for the users in the first group:
constructing a first user matrix indicating Euclidean distances among the users with respect to the first set of one or more user attributes;
constructing a second user matrix indicating Euclidean distances among the users with respect to a second set of one or more user attributes; and
determining the similarity score among the users in the first group using the first and second user matrixes.

5. The method of claim 4, wherein determining the similarity scores among the users in the group based on multiple user attributes including the first set of one or more user attributes further comprises:
for the users in the first group:
constructing a third user matrix indicating user viewing activities with respect to a first type of web items; and wherein, the determination of the similarity score among the users in the first group further uses the third user matrix.

6. The method of claim 5, wherein the first type of web items include webpages comprising information regarding real-estate properties.

7. The method of claim 5, wherein determining the similarity scores among the users in the group based on multiple user attributes including the first set of one or more user attributes further comprises:
for the users in the first group:
constructing a fourth user matrix indicating user viewing activities with respect to a second type of web items; and wherein, the determination of the similarity score among the users in the first group further uses the fourth user matrix.

8. The method of claim 5, wherein the second type of web items include webpages comprising information regarding investment items including stocks, bonds, or mutual funds.

9. The method of claim 1, wherein the recommendation includes information recommending a web item that has been viewed by at least some of the one or more users similar to the first user.

10. The method of claim 1, wherein the recommendation includes information recommending the first user to form a user group with at least some of the one or more users similar to the first user.

11. A system for generating a recommendation to a first user, the system comprising a processor configured to execute computer program components such that when the computer program components are executed, the processor is caused to perform:
receiving information regarding users from user devices associated with the users;
dividing the users into user groups using the received information based on a first set of one or more user attributes regarding the users, the user groups including a first user group;
for each user group:
determining similarity scores among the users in the group based on the first set of one or more user attributes;
receiving, from a user device associated with a first user, a request for recommending users to the first user, the first user being in the first user group;
in response to the request from the first user:
determining one or more users similar to the first user such that each of the one or more users has a similarity score with respect to the first user that is above a threshold similarity score; and
generating a recommendation for presentation on the user device associated with the first user based on the one or more users similar to the first user.

12. The system of claim 11, wherein the first set of one or more user attributes include one or more personal factors regarding the users, one or more investment factors regarding the users, and/or one or more web viewing factors regarding the users.

13. The system of claim 11, wherein dividing the users into user groups using the received information based on the first set of one or more user attributes comprises:
applying K-means clustering to the users based on the first set of one or more user attributes.

14. The system of claim 11, wherein determining the similarity scores among the users in the group based on multiple user attributes including the first set of one or more user attributes comprises:
for the users in the first group:
constructing a first user matrix indicating Euclidean distances among the users with respect to the first set of one or more user attributes;
constructing a second user matrix indicating Euclidean distances among the users with respect to a second set of one or more user attributes; and
determining the similarity score among the users in the first group using the first and second user matrixes.

15. The system of claim 14, wherein determining the similarity scores among the users in the group based on multiple user attributes including the first set of one or more user attributes further comprises:
for the users in the first group:
constructing a third user matrix indicating user viewing activities with respect to a first type of web items; and wherein, the determination of the similarity score among the users in the first group further uses the third user matrix.

16. The system of claim 15, wherein the first type of web items include webpages comprising information regarding real-estate properties.

17. The system of claim 15, wherein determining the similarity scores among the users in the group based on multiple user attributes including the first set of one or more user attributes further comprises:
for the users in the first group:
constructing a fourth user matrix indicating user viewing activities with respect to a second type of web items; and wherein, the determination of the similarity score among the users in the first group further uses the fourth user matrix.

18. The system of claim 15, wherein the second type of web items include webpages comprising information regarding investment items including stocks, bonds, or mutual funds.

19. The system of claim 11, wherein the recommendation includes information recommending a web item that has been viewed by at least some of the one or more users similar to the first user.

20. The system of claim 11, wherein the recommendation includes information recommending the first user to form a user group with at least some of the one or more users similar to the first user.
